(19) United States
(12) Patent Application Publication
(10) Pub. No.: US 2024/0257415 A1
(43) Pub. Date: Aug. 1, 2024

(54) AUGMENTED REALITY (AR) COLLABORATIVE SYSTEM DESIGNED FOR REMOTE INSTRUCTION OVER LIVE MOBILE VIEWS

(71) Applicants: UNIVERSITY OF MARYLAND, BALTIMORE COUNTY, Baltimore, MD (US); SORBONNE UNIVERSITE, Paris (FR); CENTRE NATIONAL DE LA RECHERCHE SCIENTIFIQUE, Paris (FR); INSTITUT NATIONAL DE LA SANTE ET DE LA RECHERCHE MEDICALE, Paris (FR)

(72) Inventors: Helena MENTIS, Baltimore, MD (US); Jwawon Seo, Catonsville, MD (US); Ignacio Avellino, Paris (FR)

(21) Appl. No.: 18/427,265

(22) Filed: Jan. 30, 2024

Related U.S. Application Data
(60) Provisional application No. 63/482,373, filed on Jan. 31, 2023.

(51) Int. Cl. G06T 11/20; G06F 3/01; G06F 3/0354; G06F 3/14

(52) U.S. Cl. CPC G06T 11/203; G06F 3/011; G06F 3/03547; G06F 3/1454

(57) ABSTRACT

The present disclosure provides an augmented reality, head mounted display, based collaborative system designed for remote instruction over live mobile views during physical tasks. The collaborative system includes a world-stabilized area where remote helpers can dynamically place a pointer and annotations on the physical environment, and an indirect input mechanism with an absolute position to the world-stabilized area. Examples provided within show how the described system worked for participants engaged in a remote instructional task and how they supported effective and efficient communication.

### RELATED APPLICATIONS

This application claims priority to and the benefit of U.S. Provisional Patent Application No. 63/482,373 filed Jan. 31, 2023, which is incorporated herein by reference in its entirety for all purposes.

### GOVERNMENT FUNDING

This invention was made with Government support under Federal Grant Nos. U.S. Pat. No. 1,552,837 and BCS-2026510 awarded by the National Science Foundation. The Federal Government has certain rights to the invention.

### BACKGROUND

The introduction of Augmented Reality (AR) Head Mounted Displays (HMDs) in collaboration between remote and local workers, introduces new challenges given that camera views are now mobile. The present disclosure provides an AR HMD-based collaborative system designed for remote instruction over live mobile views during physical tasks. The collaborative system includes a world-stabilized area where remote helpers can dynamically place a pointer and annotations on the physical environment, and an indirect input mechanism with an absolute position to the world-stabilized area. Examples provided within show how the described system worked for participants engaged in a remote instructional task and how they supported effective and efficient communication.

### SUMMARY

The Summary is provided to introduce a selection of concepts that are further described below in the Detailed Description. This Summary is not intended to identify key or essential features of the claimed subject matter, nor is it intended to be used as an aid in limiting the scope of the claimed subject matter.

Embodiments of the present disclosure includes a collaborative work system comprising: a head mounted device, sized and configured to be worn by a local worker, including a worker display and a camera configured to capture a video feed from the perspective of the local worker; an input device configured to accept inputs from a remote helper, including, a helper display; and a shared virtual workspace displayed on the worker display and the helper display, comprising the video feed and annotations corresponding to the received inputs.

In some embodiments, the virtual workspace further comprises a fixed coordinate space within a world-stabilized two-dimensional plane.

In some embodiments, the virtual workspace includes a cursor configured to move according to the inputs from the remote helper.

In some embodiments, the input device includes a touchpad configured to accept touch inputs from the remote helper.

In some embodiments, the input device includes an erase function configured to erase select annotations.

In some embodiments, the system further comprises a communication device configured to send and receive instructions between the local worker and the remote helper.

In some embodiments, the communication device is a two-way audio-based communication device.

Embodiments of the present disclosure include a method for collaborative work, the method comprising: capturing a video feed from the perspective of a local worker; projecting a virtual workspace over the video feed; displaying said video feed to a remote helper; recording inputs from the remote helper in the form of annotations; combining video feed and annotations to create an annotated video; and displaying annotated video feed to local worker.

In some embodiments, the method further comprises projecting a fixed coordinate space within a world-stabilized two-dimensional plane within the workspace.

In some embodiments, the method further comprises erasing annotations after annotated video is displayed to local worker.

In some embodiments, the method further comprises manipulating a cursor within the workspace.

In some embodiments, the method further comprises sending audio instructions between the local worker and the remote helper.

In some embodiments, the annotated video is displayed to the local worker using an augmented reality headset.

In some embodiments, the inputs are recorded using a touchpad.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The accompanying figures are provided by way of illustration and not by way of limitation.

FIG. 1 is a diagram illustrating an overview of the disclosed system. (a) A local worker wears an AR HMD while performing a physical task. They see a world-stabilized, 2D Actionport (green square) overlaid on their physical workspace. Within the Actionport's boundaries is displayed the remote helper's annotations and pointer (pointer is a green dot on right side of green flat building block plate). (b) A remote helper sits in front of a computer display and uses the Actionpad to point and draw in the Actionport

FIG. 2 is a visual illustration demonstrating the use of the raycast for placement of the Actionport.

FIG. 3 is a graph of remote helpers' ratings for the group of questions Q4_R (y-axis). The x-axis corresponds to the counts for each Likert scale level. (Questions (i), (ii), and (v) had 1 n/a; (iv) had 2 n/a).

FIG. 4 is a visual demonstration showing alignment of the pointer. Vignette 1. (a) A remote helper is pointing at a green block (pointer is a green dot on the red square block). (b) A remote worker is placing the green block where the pointer is indicating.

FIG. 5 is a visual demonstration showing accurately aligned annotations. Vignette 2. (a) A remote helper draws the fourth dot on the green block. (b) A remote helper moves the pointer towards the middle of the four dots.

FIG. 6 is a graph of local workers' ratings for the group of questions Q4_L (y-axis). The x-axis corresponds to the counts for each Likert scale level. (Question (iii) had 1 n/a; (iv) had 5 n/a; and (v) had 2 n/a).

FIG. 7 is a visual demonstration of instruction using movement of the Pointer. Vignette 3. (a) A remote helper is pointing at a green block. (b) A remote helper moves the pointer towards a location where the block should be placed.

FIG. 8 is a visual demonstration of a local worker aligning a block in the direction of the annotation. Vignette 4. (a) A remote helper is drawing an annotation to indicate the direction of a block (Annotation is a red line on the red block). (b) A block is placed by the local worker along the direction indicated.

FIG. 9 is a visual demonstration of the disclosed system supporting pointing over the live mobile view. Vignette 5. (a) A remote helper is placing the pointer over a yellow block. (b) A local worker moves head pose towards the pointer. (c) The head movement changes while the local worker is moving the yellow block.

FIG. 10 is a visual demonstration of an obfuscation of the pointer's location. Vignette 6. (a) A remote helper is pointing at the first row of a green block. (b) A blue block is placed on the pointer's location and the pointer is placed on the second row of the blue block.

FIG. 11 is a visual demonstration of drawing an annotation independently of the live mobile view. Vignette 7. (a) A remote helper is drawing through the Actionpad. (b) The pointer is moved out of the live mobile view. (c) The annotation is drawn seamlessly. Note that in figures (b) and (c), the remote helper had previously rotated the view.

FIG. 12 is a visual demonstration of establishing alignment between Actionpad and Actionport. Vignette 8. (a) A remote helper is looking towards the Actionpad and moving their finger towards it. (b) The remote helper is looking at the Actionport while moving his finger on the Actionpad.

FIG. 13 is a visual demonstration of a remote helper recognizing the relationship between the Actionpad and the Actionport. Vignette 9. (a) A remote helper is moving the pointer to the left in the Actionpad, and the pointer is moving upward on the screen. (b) The remote helper is rotating the Actionpad. (c) The remote helper recognizes the pointer is moving in the same direction as her hand gesture.

### DETAILED DESCRIPTION

Section headings as used in this section and the entire disclosure herein are merely for organizational purposes and are not intended to be limiting.

### 1. Definitions

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. By way of example, “an element” means at least one element and can include more than one element. The present disclosure also contemplates other embodiments “comprising,” “consisting of” and “consisting essentially of,” the embodiments or elements presented herein, whether explicitly set forth or not. As used herein, “and/or” refers to and encompasses any and all possible combinations of one or more of the associated listed items, as well as the lack of combinations where interpreted in the alternative (“or”).

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated. Recitation of ranges of values herein are merely intended to serve as a shorthand method of referring individually to each separate value falling within the range, unless otherwise-Indicated herein, and each separate value is incorporated into the specification as if it were individually recited herein. For example, if a numerical range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure. “About” or “approximately” is used to provide flexibility to a numerical range endpoint by providing that a given value may be “slightly above” or “slightly below” the endpoint without affecting the desired result.

Unless otherwise defined herein, scientific and technical terms used in connection with the present disclosure shall have the meanings that are commonly understood by those of ordinary skill in the art. The meaning and scope of the terms should be clear; in the event, however of any latent ambiguity, definitions provided herein take precedent over any dictionary or extrinsic definition. Further, unless otherwise required by context, singular terms shall include pluralities and plural terms shall include the singular.

### 2. Introduction

Collaborative systems that provide shared visual information through shared workspaces, as provided in the present disclosure, improve situation awareness and are resources during conversational grounding, improving communication between collaborators, and virtual pointing in shared workspaces improves performance by reducing movement quantity for physical tasks as implicit guidance becomes explicit visual cues. Using Augment Reality (AR) and a Head Mounted Display (HMD), a remote helper can view a local worker's physical workspace and directly augment the local worker's view.

However, numerous challenges arise when designing for remote instruction through an AR HMD. One significant challenge is there is a shift from a fixed view to a mobile view, that is, the camera is no longer in a fixed position, but rather it moves with respect to the worker's position through an HMD or any mobile device. Referencing objects is difficult with a mobile camera and so typically a local worker is required to move carefully to a suitable location where the remote helper can then refer to a target object. Without this coordinated manual stabilization of the view, it is not clear how remote helpers can dynamically create stabilized annotations for instruction—i.e., how to point or draw a circle on a real-world object while the camera moves about in the space. The primary obstacle with a moving camera is that, as a remote expert clicks on a pixel at a given moment to draw, the next moment that pixel corresponds to another location in the local person's real world. One approach to overcome this obstacle is to require the remote expert to take a snapshot of the view before interacting on it; essentially “freezing” in time the shared workspace, drawing on it, and then either the system (a) presents it as a floating image, or (b) transfers the finished drawing as a stabilized annotation on the local worker's HMD. However, the “freeze” approach limits the remote helper's ability to engage in deictic referencing—i.e. dynamically pointing or annotating while providing verbal utterances such as “here”—which is important for facilitating clear as well as efficient communication.

Working on these challenges is a pressing concern as AR HMDs become more common and available as a consumer technology. The present provides an AR HMD-based collaborative system disclosure (sometimes referred to as the “HoloMentor” herein) designed for remote instruction over live mobile views during local worker's completion of physical tasks. The present disclosure provides at least two advantages: (1) dynamically aligning a pointer on a live mobile view, i.e. without the need for the remote helper to freeze the view, and (2) providing an accurate and intuitive interaction mechanism for a remote helper to point and annotate on those live mobile views. Experimental results using the disclosed system are provided within involving a local worker completing a building-blocks task via the instruction of a remote helper.

Experimental evaluations show that the pointer and the annotations were sufficiently accurate for the remote helper to use them during instruction and clear for the local worker to understand their reference. In addition, the remote worker was able to understand how to reliably use the disclosed input method for moving over the live mobile view. Both of these aspects enabled the remote helper to provide clear instructions through dynamic pointing and annotating over live mobile views.

### 3. Design Characteristics

The disclosed system includes several design characteristics.

Local worker. Local workers are responsible for the live mobile view, as they wear the AR HMD on their heads. The local worker's head movement, and corresponding view, may be constrained or free. Constraining head movement entails a social rather than technical solution. It includes having the remote helper ask the local person to stay still when annotating. The advantage with this approach is that there is no synchrony problem (both remote and local collaborators see the same view) and minimal movement means any pointing or annotating is accurately placed on that view. However, in environments that are already cognitively and physically taxing, such as in surgical telementoring or paramedic teleconsulting, this approach puts an additional coordinative burden. In fact, interacting with supporting technologies for secondary tasks while performing a complex primary task like surgery can interfere with cognitive and physical demands of the latter, which in turn has been shown to lead to errors. Thus, the disclosed system aims to unnecessarily constrain the local worker's movements by supporting dynamic tasks.

Remote helper. Remote helpers are responsible for pointing and creating annotations, to which the system provides feedback. Most important to note is that existing solutions do not provide a pointer that can represent the remote helper's dynamic cursor movements over a snapshot or a live view. Such deictic referencing is an important part of remote instruction. Thus, the disclosed system includes a mechanism for both pointing as well as annotating a live mobile view as one would naturally do on a static video image.

Output. Output—visualization of the pointer or annotation locations—could happen on the shared view, or elsewhere. In order to support live mobile views, and dynamic worlds, the helpers need to focus their attention on the shared view, thus, all output reside there. The pointer and annotations are fixed on the real world by making them world-stabilized. Because the volume where the pointer and annotations can live is potentially infinite (and mostly irrelevant to the task), the output space is constrained to a 2D plane where the task is executed, such as a table, rather than a 3D volume. The output space is then further constrained to a portion of this plane, where most of the task takes place.

Input. The input mechanism needs to accurately and intuitively interact in the 2D input surface showing the live mobile view. The helper could use the desktop mouse to click on the video, and then project that point to the output space to produce an annotation. However, as soon as the view changes from the worker moving their head, the pixel that the remote worker clicks also changes. Therefore, if the helper looks away when the helper clicks to annotate, the result is the unintended annotation of a line that follows the head movement. The disclosed system creates a fixed coordinate space for both users, by transforming the XY coordinates of the mouse cursor in the video window, to the corresponding XY coordinates of the output space, assuming border alignment. The output space is defined as a rectangle on the table in front of the worker. As such, when a remote helper would move their mouse towards the upper right corner of the video display window, the AR pointer would correspondingly move to the upper right corner of the output space. As this would result in having two cursors/pointers on the remote helper's video display window, which would be confusing for a remote helper, the mouse cursor is made invisible when in the video display window's bounds.

### 4. Description of Disclosed System

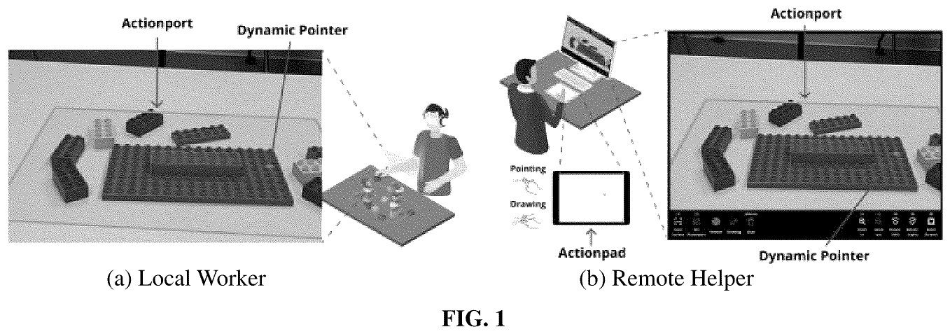

The disclosed system is an AR HMD-based collaborative system designed for remote instruction over live mobile views during local worker's completion of physical tasks. The disclosed system addresses two significant challenges: (1) dynamically aligning a pointer on a live mobile view, i.e. without the need for the remote helper to freeze the view, and (2) providing an interaction mechanism for a remote helper to point and annotate on those live mobile views. The basis of the disclosed system consists of two parts: a desktop application for the remote helper (FIG. 1(b)); and a AR HMD application (HoloLens2) for the local worker (FIG. 1(a)). The desktop application provided the remote worker with the ability to point on, annotate, and erase annotations on, rotate, and zoom in/out the remote helper's video view. In some embodiments, the desktop and HoloLens2 apps are programmed in Unity 2019.3.13f1 and the MixedReality-WebRTC framework is used to establish a two-way audio and one-way video connection between the HoloLens2 app and the desktop app over a local WiFi network. Video is captured using the HoloLens2 world-facing camera and streamed to the remote helper's application enabling the remote helper to see the environment the local worker is looking at in real-time.

a. Actionport

The Actionport provides remote helpers with pointing and annotating functionality over a live stream from the local worker's head-mounted camera and is placed by the remote helper in a fixed position as a virtual overlay in the local worker's physical environment. By fixing the position of the Actionport, there is now a stable, defined space in the local worker's environment with a one-to-one mapping to a defined space on the remote helper's display. This defined shared workspace is not affected by the movement of the camera, thus a remote helper can control a cursor in the space to dynamically point or draw. For instance, when a remote technician points to a wire on a control panel and then the local technician moves their head to the right by 2 inches, the pointer remains over the wire.

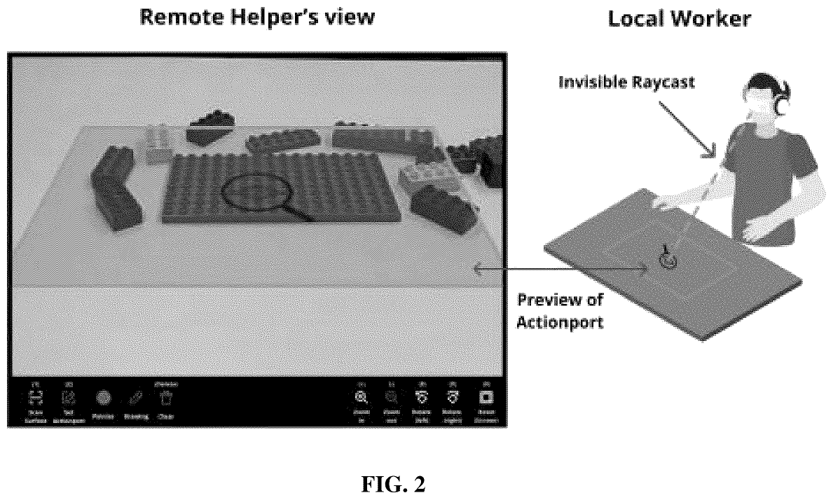

A feedforward mechanism is provide in order to facilitate remote and local worker coordination in the placement of the Actionport. Even though the remote helper cannot move the position of the Actionport themselves, they can coordinate with the local workers to place the Actionport through this feedforward mechanism. This enables both collaborators to preview where an Actionport will be placed by using a raycast along the local worker's gaze direction (FIG. 2). The remote helper then pushes a button on the remote desktop application's toolbar to affix the Actionport to the area shown in the preview. An Actionport is then displayed as a green rectangle in the shared workspace seen by both the local and remote helper (as shown in FIG. 1(b)). Once the Actionport is placed, the remote helper's pointing functionality is automatically activated.

### (1) Actionport Development

In some embodiments, the spatial mapping feature of the open-sourced Mixed Reality Toolkit is used to stabilize the Actionport and its content (i.e. the pointer and annotations) in the local worker's environment. The spatial mapping feature creates triangle meshes on real-world surfaces in the environment around the Microsoft HoloLens device. First, the nearest spatial surface where the Actionport will be overlaid by using a raycast which lies within the camera's view orientation is identified. Then, a position and a normal vector (ic, a vector perpendicular to a plane) of a triangle mesh that the ray hit is calculated. An Actionport is placed here and with the normal vector parallel to the triangle mesh. Also, to rotate the bottom direction of the Actionport toward the local worker, a vector between the position of the local worker and the Actionport is calculated, and then adjusted the x angle of the Actionport.

b. Actionpad

The Actionpad, an indirect input mechanism, is provided for remote helpers to act on a tablet through touch and perceive the effect in the Actionport on the desktop application's video display window (FIG. 1(b)). The tablet face's rectangular boundaries represented the Actionport's rectangular boundaries and so when moving one's finger on the tablet's face the HoloLens' pointer would move in the corresponding XY coordinates in the Actionport. Also, if the remote helper rotates the video display, they could rotate the tablet in accordance with the resulting orientation of the Actionport to make it easier to map the movement of the finger with the intended movement of the pointer. Based on an indirect input mechanism and one-to-one mapping, the Actionpad provided feedback for the remote helper to determine whether their cursor's location is in real-time. In some embodiments, two interactions are provided: to move a pointer, a user touches the touchscreen with one finger and moves it over the surface in the XY plane, and to draw, the user touches the touchscreen with two fingers and moves them in tandem over the surface. The user could change from one to two finger and back again, akin to a clutch mechanism, to switch modes seamlessly, e.g. move the cursor to a starting point, drop the second finger to the surface of the touchscreen, move both fingers in tandem to draw a line, raise the second finger to stop drawing.

### (1) Actionpad Development

In some embodiments, a web-application loaded on a tablet (FIG. 1(b)) as an accompaniment to the desktop application is provided. The web app was programmed with JavaScript and websockets through the Socket.io2 library is used to stream touch interaction from the tablet to the desktop app. Photon Unity Networking 23 (Photon Engine) is used to synchronize the pointer and drawings over the network.

### 5. Evaluation Method

The disclosed system was experimentally evaluated using the method described below.

a. Participants

Sixteen participants were recruited in June 2021, through targeted email solicitation. Once participants replied with their interest to participate, they were manually paired based on their availability. All of the participants were between 18-30 years of age, of which four identified as female and twelve as male and none had any prior experience with the Microsoft HoloLens.

b. Procedure

Each participant was placed in a separate room. The participant who played the role of the remote helper was sat in front of a desktop computer and provided a mouse, keyboard, and the Actionpad tablet. The participant who played the role of a local worker was sat at a table and provided with the HoloLens2 AR glasses. The communication between the remote helper and the local worker to complete the task was accomplished solely by using the HoloMentor's two-way audio channel, video from the AR HMD system, and augmented reality visual overlays.

After consent was attained, a pre-questionnaire was distributed. After completion of the pre-questionnaire, each participant watched the same introductory presentation that outlined how the system worked (e.g. how to set the Actionport, how to use the Actionpad) and how HoloMentor could be used for remote instruction. After completion, the participants then engaged in a practice task with HoloMentor. The remote helper was provided with a drawing of a house and a guide that ensured the participants would gain experience in using each functionality at least once. The local worker was provided a pen and a plain sheet of paper. During and after the practice task, both the participants were free to ask any clarification questions to the researchers.

The participants were then introduced to the main task: building a blocks structure. The remote helper was presented a pre-built structure situated on a base board. The base board was fixed to the table such that the remote helper can view the structure but not move it in any direction. The local worker was presented with several building blocks and a fixed base board in front of them. The base board of the local worker was fixed horizontally and the base board of the remote helper was fixed vertically. The fact that the two base boards are differently fixed at an angle of 90 degrees is deliberately designed to encourage the remote helper to use the provided rotate screen functionality. This additionally also provided the opportunity to see if and how the remote helper oriented the Actionpad to align with the orientation of the Actionport.

When the main task began, the remote helper instructed the local worker using HoloMentor. After successfully completing the task, each participant was presented a post-questionnaire. The participants then switched rooms and thereby switched roles. Another practice task was completed with a different drawing, followed by the main task again. For the second round of the main task, a different building blocks structure was assigned to the remote helper to avoid a learning effect. A second post-questionnaire was filled out by the participants to elaborate on their new role as a remote helper and local worker accordingly.

Lastly, a semi-structured interview was conducted where both researchers and both participants gathered in one large room. The interview contained questions from what the researchers observed during the main tasks and other questions from an interview script. Each participant took turns to answer each question in their role as a remote helper and a local worker.

c. Data Collection

Audio-Video Recordings & Notes: The interaction between participants during the main task was audio and video recorded using Go Pro cameras in each room and using a screen recorder software to capture the use of HoloMentor on a desktop. The placement of the cameras captured the desktop application's display, the interactions with the Actionpad, the profile of the remote helper, and the upper body and workspace of the local worker. The researchers also took observation notes during the main task.

Post-Interview: After participants performed two main tasks, the researchers and the participants came together for a semi-structured interview that was audio recorded. The interview consisted of semi-structured questions as well as additional questions added from what the researchers observed during the main tasks. Each participant took turns to answer each question in their role as a remote helper and a local worker.

Questionnaires: (1) A pre-questionnaire that included demographic questions and information about participants' previous experience with AR and the Microsoft HoloLens equipment. (2) Two post-questionnaires—one for the remote helper and one for the local worker. The questions were designed to gather information about the usefulness of the disclosed system's functionality and how or why they chose to use any functionality when the participant performed each role. The remote helper post-questionnaire specifically asked how useful they were for using the system's functions (Q1, Q2, and Q3) and how they used the functions to convey remote instructions (Q4 and Q5). The local worker post-questionnaire specifically asked whether the features were useful to perform physical tasks (Q1 and Q2) and how easy to understand the remote helper's action (Q3 and Q4). The questions were in the form of 5-point Likert scales (1=Strongly Disagree, 5=Strongly Agree).

d. Data Analysis

Three sets of data were analyzed and triangulated. First, the interaction videos captured during the main task were analyzed. Each significant moment when a remote worker used the Actionport or Actionpad to instruct on the main task was first highlighted in this data. This practice includes a detailed reflective analysis that captures utterances, pauses, overlaps, intonations, and visible actions. In the presented vignettes, the participant number and then the role the participant was playing is indicated through notation (e.g. P5RH for Participant 5 playing the Remote Helper, P6Lw for Participant 6 playing the Local Worker). The usability of the Actionport and the Actionpad were the focus: specifically, the accuracy of use of the pointer, understanding the relationship between the Actionport and the Actionpad, and how and when the remote helper uses the pointer and annotations instead of verbal instructions. The participants' behaviors were carefully observed, such as how they communicated through the Actionport, how the remote helper used the Actionpad, and how local workers responded to the information they received.

Second, the interview data was transcribed using Otter.ai and then manually checked for missing data. Using NVivo software, evaluators open-coded the transcribed data along with the questionnaire's open-ended answers to identify themes regarding the tools' use. Using selective coding, they then categorized those themes based on common patterns. A detailed description of the particular qualitative themes that reflect the participants' thoughts regarding the dynamic pointer, annotations, the Actionpad, and the Actionport were the focus. For example, evaluators identified how the dynamic pointer affects the remote helper's instructions. By integrating the conversation analysis and the interview analysis, evaluators generated 32 initial open codes that helped mark the content and organize it in a meaningful way. The final high-level themes were associated with the quality of deictic reference by the pointer and annotations, the relationship between the Actionpad and the Actionport, and point/annotate on live mobile views.

Third, the questionnaires' Likert scale responses were descriptively analyzed and the counts were reported as the median (M), standard deviation (SD), and in diverging bar charts. Although the design of the study does not allow for inferential statistical analysis, descriptive statistics are presented as evidence in support of the primary qualitative analysis.

### 6. RESULTS

The disclosed system helps the remote helpers overcome the challenge caused by pointing and annotating over live mobile views during the local worker's completion of physical tasks, as shown using the following vignettes.

a. Alignment of Pointer and Annotations with Actionports

The first research question was whether the Actionport was able to sufficiently align the remote helper's dynamic pointer and annotations and maintain that alignment with a mobile camera view. Evidence of this is presented through two types of examples: (1) the remote helper's demonstrated satisfaction with the alignment of the pointer and the intended target; and, (2) the local worker's demonstrated ability to understand the locations referred to and instructions provided by the remote helper.

(2) Actionport Provides Remote Workers with Good Alignment of a Dynamic Pointer and Annotations on Intended Physical World Target.

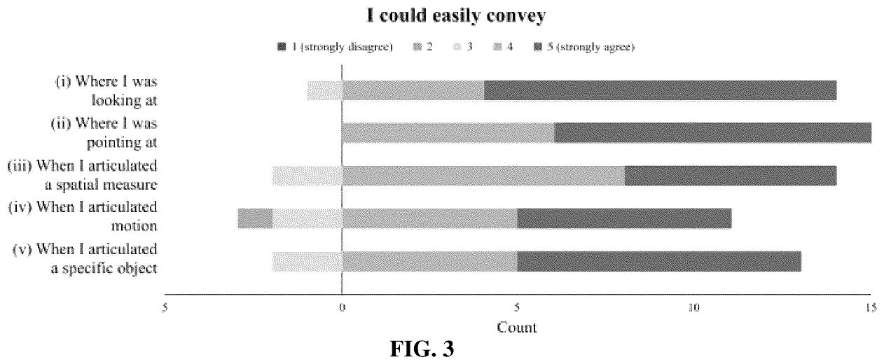

To investigate pointer accuracy during instruction, quantitative data is presented from the post-questionnaire, and then qualitative analysis of the video data and interviews. Participants acting as remote helpers rated highly their perception on the case with which to convey where they were looking (M=5, SD=0.63 on a 5 point scale), where they were pointing (M=5, SD=0.51), when articulating a spatial measure (M=4, SD=0.68), motion (M=4, SD=95), and specific objects (M=5, SD=0.74). As shown in FIG. 3, the great majority of responses are above 4.0. The remote helpers tend to rate highly for where they were looking at and where they were pointing.

Through analysis of the video data, one sees that as the remote helpers used the pointer and annotation tools to provide instructions, the sixteen participants showed no evidence of being unsatisfied with the alignment of the dynamic pointer/annotation on the view. Overall, the evidence shows seamless use of the pointer and annotations to share location or placement instructions.

In Vignette 1, the remote helper is moving his pointer towards the location of the next block placement. He is able to show and verbally reference the location without any pause to correct the alignment. In addition, his affirmation that the local worker placed the block in the location he indicated.

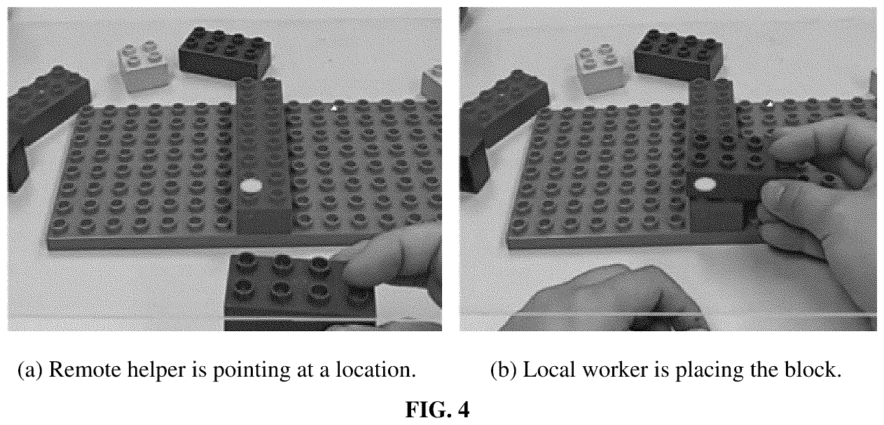

Vignette 1

| | |
|---|---|
| P5_{RH}: | [You're going to place it ] |
| | [((Moving the pointer towards block))] (2.0) |
| | It's the second. (3.0) ((Stops moving the pointer and hovers over stud)) In this corner. |
| | I mean, top of the red bar. ((FIG. 4(a))) |
| P6_{LW}: | ((Moves the block towards pointer and begins to place the block down over pointer)) |
| | ((FIG. 4(b))) Like this? |
| P5_{RH}: | Yes, like that. Yes. |

In Vignette 1, the remote helper dynamically moves the pointer over the live mobile view while simultaneously talking to the local worker. Because of the stability of Actionport over the live mobile view, there was a reference frame for the pointer to then be able to move over this live view and accurately point to a location on it. This was perceived to be sufficiently accurate by all of the remote worker participants. Thus, they mainly used the pointer for instructions they provided the local workers. Evaluators counted every instances remote helpers used the pointer (113), annotations (83), or verbal only (83) at each instruction moment, and the pointer was used for 40.5% of instructions.

Likewise, during the post-study interviews, no participants present examples or complaints that the pointer was not accurate enough for their use. If discussed at all, the participants would focus on the ability the pointer provided them in making their references clear. For instance, the following are examples of the participant's reflection in reference to the accuracy of the pointer.

“If I was pointing [at] a block with a pointer, he was very easily going to pick it up. And we could move forward to the task. I overall thought that he understood what I was trying to convey.”-P5_{RH}

“As [a remote helper], I found it much easier to convey what I wanted along with the ability to point to the object that I want.”-P11_{RH}

In addition to pointing, annotations were also perceived to be correctly aligned with the intended target. Vignette 2 depicts an occasion where a remote helper drew four dots to guide the local worker in placing a square block. The four dots were fixed to the correct position on the green block, so the local worker placed the square block in that position. After drawing the four dots, the remote helper instructed the placement of the block by moving the pointer to its center.

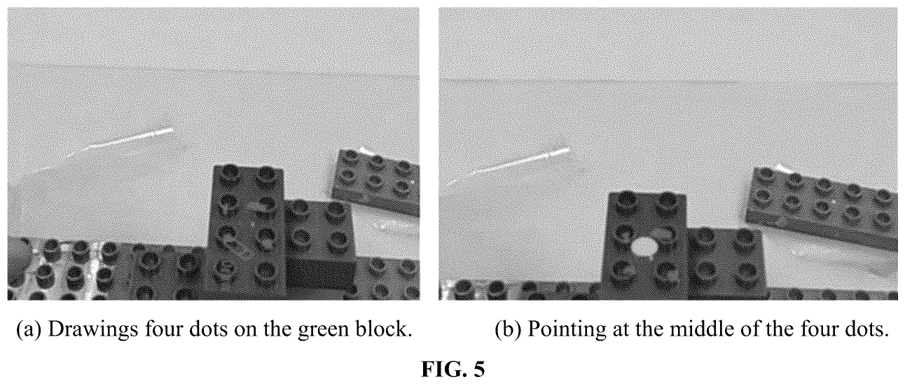

Vignette 2

| | |
|---|---|
| P3_{RH}: | Hold on. Let me try something else. Let me just um. (2.0) How about put it on (5.0) |
| | ((Draws a dot on a stud of the green block)) (2.0) ((Draws the second dot on the next |
| | stud of the green block)) These four dots at (1.0) ((Draws the third dot)) (2.0) |
| | ((Draws the fourth dot)) Put it on this. (2.0) That makes sense. (3.0) ((FIG. 5(a))) |
| P3_{RH}: | [So place it right here ] |
| | [((Moves the pointer to the middle of the dots))] ((FIG. 5(b))) |

A key assessment of the suitability of the disclosed solution is whether it can accurately maintain the placement of a pointer or annotation despite the camera view coming from a HMD, which can introduce both slight natural head movements as well as more pronounced head re-orientation. Thus, the user's perception of placement accuracy must be evaluated. Shown through three different data types, is the overall suitability of the placement. Suitability is used because the evaluation method cannot definitively measure whether the system was 100% accurate. However, users did not perceive any significant deviation to cause them to not consider the accuracy to be supportive of all they wished to accomplish. And considering the exactness of some of the intended references and annotations, the system was still perceived to work to a high degree for the fine referencing required.

(3) Actionport Provides Local Workers with Good Alignment so they can Understand Location References.

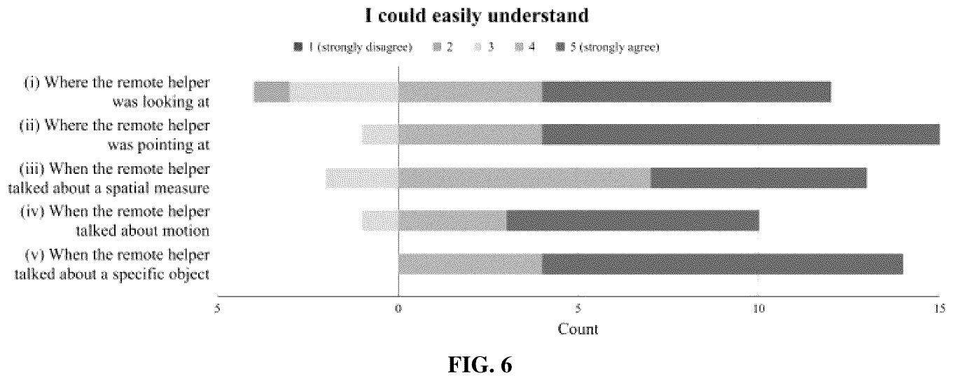

The post-questionnaire quantitative data analysis shows that local workers also responded with a high rating when asked if they could easily understand where the remote helper was looking (M=4.5, SD=0.98), pointing (M=5, SD=0.62), that they could interpret spatial measures (M=4, SD=0.70), motion (M=5, SD=0.69), and specific objects (M=5, SD=0.47). As shown in FIG. 6, the great majority of responses are above 4.0. The local workers tend to rate highly their understanding for where the remote helper was pointing and talking about a specific object.

In addition, all local workers answered that they were able to understand where the remote helper was indicating through the pointer and/or annotations.

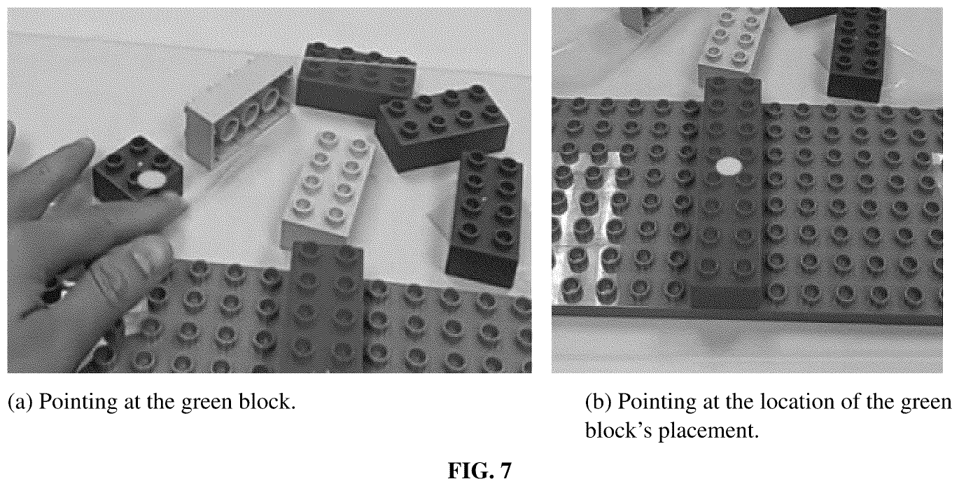

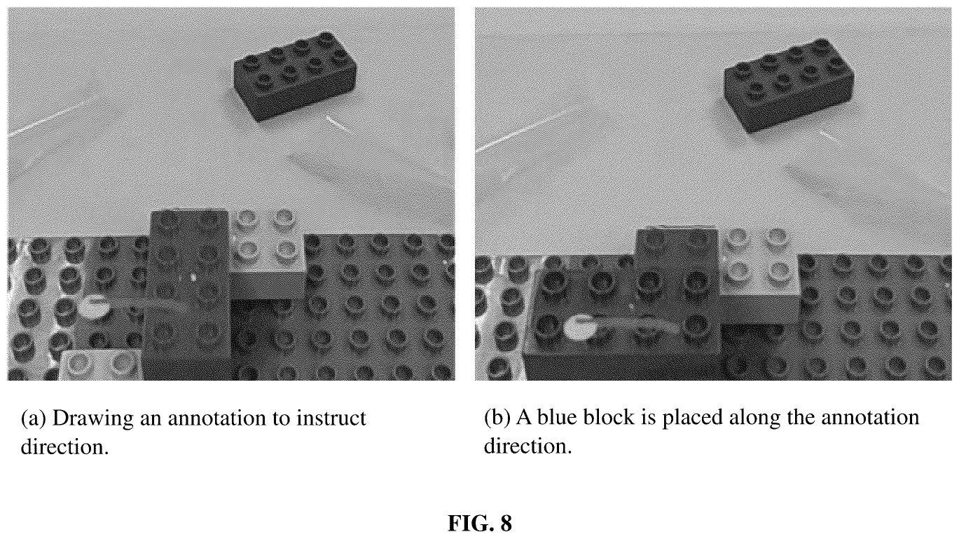

From the qualitative analysis of the video data, local workers were able to understand the particular targets being referenced by the remote workers in the course of task completion. For example, when referencing a concrete element in the real world (FIG. 7(a) and FIG. 7(b)) or when aligning a block in the direction an annotation indicated (FIG. 8(a) and FIG. 8(b)). In the following example, the remote worker is using deictic referencing with the pointer to indicate not only the object that needs to be moved, but also where to move that object.

Vignette 3

| | |
|---|---|
| P3_{RH}: | Then I want you to grab (3.0) |
| | [((Moves the pointer to the green block))] |
| | [This piece here. ] ((FIG. 7(a))) |
| P4_{LW}: | ((Grabs the green block)) |
| P3_{RH}: | [((Moves the pointer to the middle of the red block))] |
| | [I want you to put it right here. ] ((FIG. 7(b))) |
| P4_{LW}: | ((Puts the block where the pointer is)) |
| P3_{RH}: | Okay. |

In Vignette 3, the local worker being able to act in conjunction with the instructions being provided. He is able to know exactly which block to move as well as then where to move that block. There is no need for clarifying questions by the local worker, and more to the point, the collaborative pair is able to be more efficient in their communication by the remote helper using words such as “this” and “here”, and these are unambiguous statements for the local worker.

Likewise, in Vignette 4, the remote helper uses the annotation functionality to indicate the orientation of a block's placement and the local worker demonstrates the exactness of the annotation location by his ability to satisfy the request without any clarifying questions.

Vignette 4

| | |
|---|---|
| P3_{RH}: | [((Moves the pointer toward a blue block))] |
| | [Go ahead and grab this piece. ] |
| P4_{LW}: | [((Moves and grabs the blue block))] |
| P3_{RH}: | [Yap. ] And you're going to put it (2.5) ((Moves the pointer |
| | on a red block)) (1.0) |
| P3_{RH}: | [Here. ] |
| | [((Starts drawing a red line vertically)] (4.0) ((Finishes drawing the line)) ((FIG. |
| | 8(a))) |
| P4_{LW}: | [((Places the block following the direction of the line))] ((FIG. 8(b))) |
| P3_{RH}: | [Yap. Looks Good.] |

In the example from Vignette 4, the annotation was a strong indication for the local worker. The remote helper only said “here” while drawing the annotation, but the local worker saw the starting position and direction of the annotation and placed the block correctly. There was no need for a conversation to confirm the location or direction.

Finally, in this next example, one unique benefit of the disclosed system is shown. Actionport is meant to support pointing over a moving camera view in order to support complex collaborative interactions. Vignette 5 shows a pointing action while at the same time the local person moves their head, changing the view. The result is nonetheless an interlacing of talk and action by both parties that is efficient and effective in getting the work done, without significant overlap. This reinforces the communication benefit of being able to point/annotate on live mobile views during task execution.

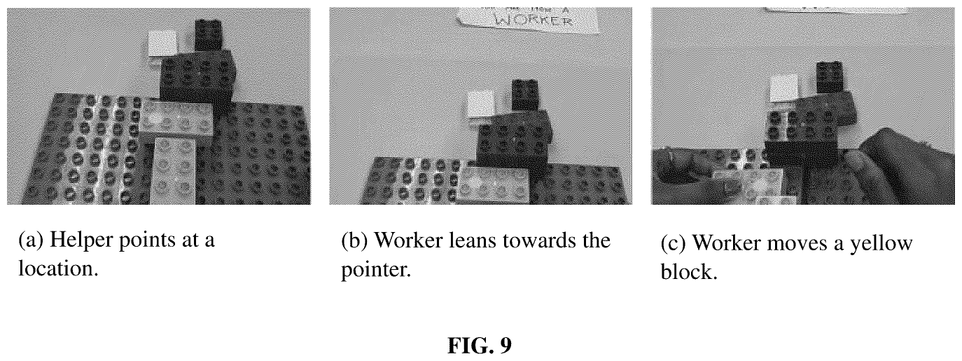

Vignette 5

| | |
|---|---|
| P13_{LW}: | ((Moves her head closer to the building block structure.)) (3.0) ((Places a building |
| | block)) |
| P12_{RH}: | Okay, move the yellow. (.) ((Points at the bottom of a horizontally placed yellow |
| | block)) |
| | (2.0) Close towards two studs, blue and yellow. ((FIG. 9(a))) |
| P13_{LW}: | ((moves her head pose up)) ((FIG. 9(b))) |
| P12_{RH}: | ((Pointer still in intended location)) Leave three positions. |
| P13_{LW}: | ((Moves the building block to the right)) |
| P12_{RH}: | ((Moves the pointer from the building block to the left side))] |
| | [Same thing. Do the other side. ] |
| P13_{LW}: | ((Still tries to putting the building block on the left)) |
| P12_{RH}: | [No, the opposite side. ] |
| | [((Points to the building block again))] (.) |
| P12_{RH}: | [((Moves the pointer to the left.)) ] |
| P13_{LW}: | ((Moves the building block to where the pointer is))] ((FIG. 9(c))) |
| P12_{RH}: | ((Keeps pointing)) Yeah, awesome. |

In this case, the pointer is shown to have sufficient alignment with both side to side head movement as well as when getting closer or further away from the physical space. This example also showed how useful this is for the collaborators as the remote helper can continue to provide deictic referencing while the local worker is moving their head. In other words, by supporting pointing over a live mobile video during instruction, the disclosed system is able to support the interlacing of talk and deictic referencing by the remote helper and natural head/body movement for closer inspection as well as physical object movement for the task at hand by the local worker.

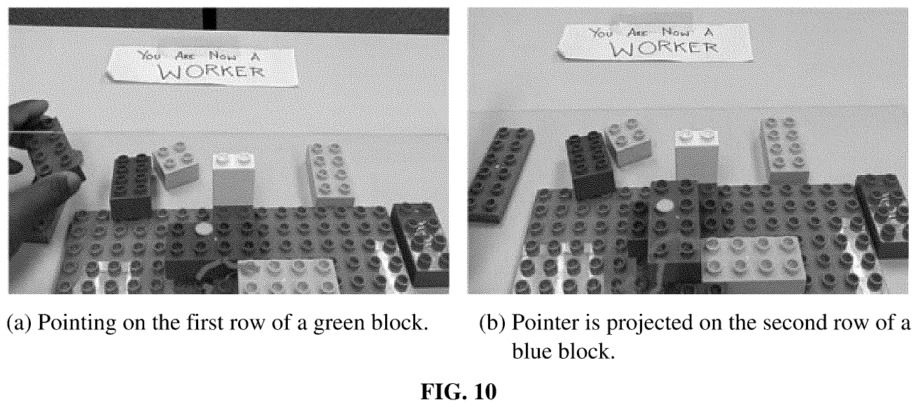

Vignette 6

| | |
|---|---|
| P9_{RH}: | ((Moves the pointer on a green block)) The first hole of the blue block on the top |
| | should align with the pointer that I am pointing right now. (FIG. 10(a)) |
| P10_{LW}: | ((Places the blue block where the pointer is pointing)) (FIG. 10(b)) |
| P9_{RH}: | ((Sees the pointer is positioned on the second row of the blue block)) Yeah, the first |
| | hole actually. |

In Vignette 6, the worker correctly placed a building block given an annotation, then the remote helper gives a new instruction, but the old annotation is now on top of the newly-placed block, and as the local worker now associates the new instruction with the old annotation, the action leads to a misplacement of the next building block. Thus, the dynamic nature of the physical world being augmented with instructions brings to light a new challenge to overcome when designing for remote annotation of live mobile views.

b. Use of the Actionpad to Point and Annotate

The remote helpers were able to effectively understand how to use the Actionpad to move the pointer and draw annotations. This is shown through examples of the remote helpers demonstrating the ability to point and annotate on the Actionpad independently of the live mobile view. Further findings on how the remote workers established their understanding of the relationship between the Actionpad screen and resulting movements of the pointer on the Actionport as well as the relationship of the orientation of the Actionpad with the orientation of the Actionport are also provided.

(1) Independent Interaction for Pointer and Annotations through Actionpad.

The remote helpers controlled the Actionport pointer with the Actionpad consistently and their actions were not affected by the live mobile view. Moments when remote helpers complained of disorientation when interacting with the Actionpad were not observed. In addition, when the pointer was not visible in the live mobile view due to the local worker's head movement, the remote helpers could continue pointing and annotating while asking the local worker to move their head back to make the pointer visible to them again.

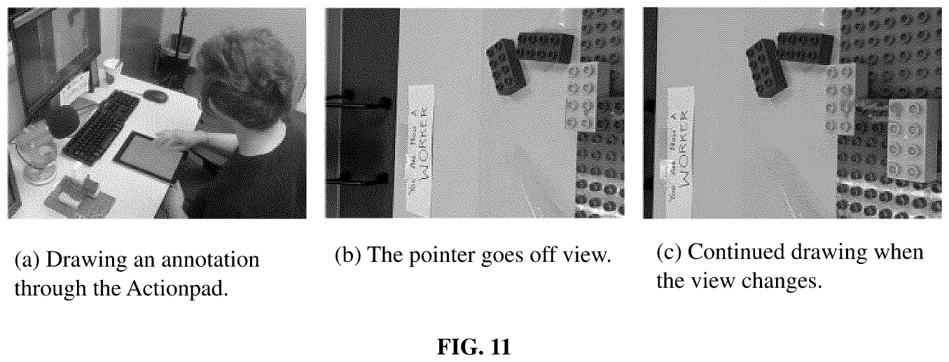

Vignette 7

| | |
|---|---|
| P3_{RH}: | ((Alternating looking at the pre-built blocks structure and the HoloMentor desktop |
| | application display)) We're going to put it. (1.0) |
| | [((Moves the pointer to the block at the far right of the screen))] (FIG. 11(a)) |
| | [Here. ] (.) |
| P3_{RH}: | ((Begins to draw a line -annotation continues out of the view in the desktop's video |
| | display window -continues drawing)) (FIG. 11(b)) (3.0) Look down a little bit. |
| P4_{LW}: | ((Looks down)) |
| P3_{RH}: | ((Continues movement of fingers on the ActionPad and then ends)) Put it right here. |
| | (FIG. 11(c)) |

As shown in Vignette 7 and FIG. 11(a), while the remote helper was drawing, he was able to move the pointer on the tablet (Actionpad), but the annotation went out of view (FIG. 11(b)). Therefore, the remote helper asked the local worker to look down, and nonetheless the pointer stayed in the same position regardless of the view changing. As soon as the remote helper saw the pointer in the live view as the local worker moved their head, he moved the pointer to continue drawing the annotation (FIG. 11(c)). This shows that the Actionpad enables the remote helper to interact with a pointer or draw independently of the local worker's head movement.

(2) Remote Workers Establish Alignment between Actionport and Actionpad.

In all cases, remote helpers first aimed to establish an alignment between their interactions on the Actionpad and the movement of their pointer in the Actionport before providing an instruction. When they wanted to move the pointer in the Actionport, first, they checked to see if their finger was positioned where they wanted on the Actionpad. Finally, while moving the pointer, they looked at whether the pointer actually moved to the location they intended in the Actionport.

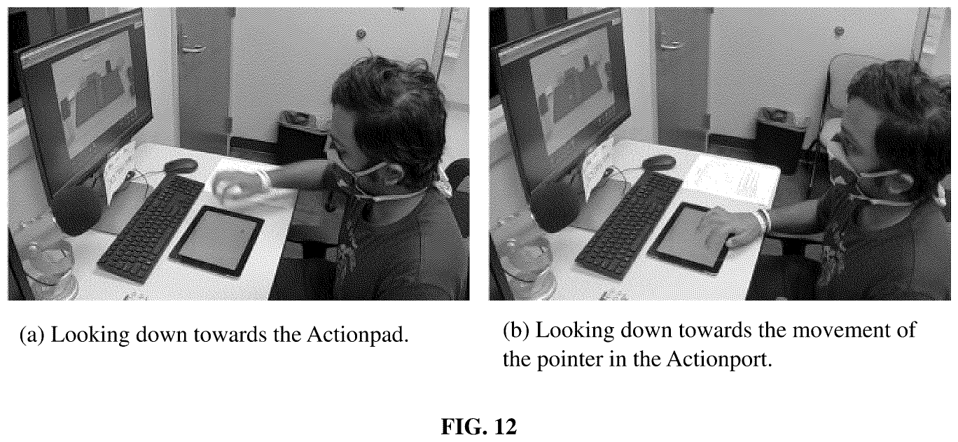

Vignette 8

| | |
|---|---|
| P16_{RH}: | ((Looks towards the screen)) (1.5) ((Looks down towards the Actionpad and touches |
| | the tablet)) (.) (FIG. 12(b)) |

P16_{RH}: ((Looks back up towards the screen)) (.) ((Moves the pointer to the left)) (FIG. 12(b))

In Vignette 8, the remote helper looked at the screen first, then the Actionpad, and then moved his finger while looking at the screen again before he began deictic referencing. Therefore, for a moment, the remote helper took the time to first check whether the interaction through the Actionpad corresponds to the movement of the Actionport's pointer. However, after learning how the two interfaces aligned, the remote helpers rarely looked at the tablet again when pointing and kept their gaze fixed on the desktop monitor when moving the pointer or drawing via the Actionpad.

(3) Coupling Rotated Actionport with Actionpad.

Remote helpers understood the relationship between the Actionpad and the Actionport. In Vignette 9, the remote helper had previously rotated the video view counterclockwise and rotated the Actionpad accordingly to align. After a while, the remote helper makes the decision to rotate the video view back to the original orientation.

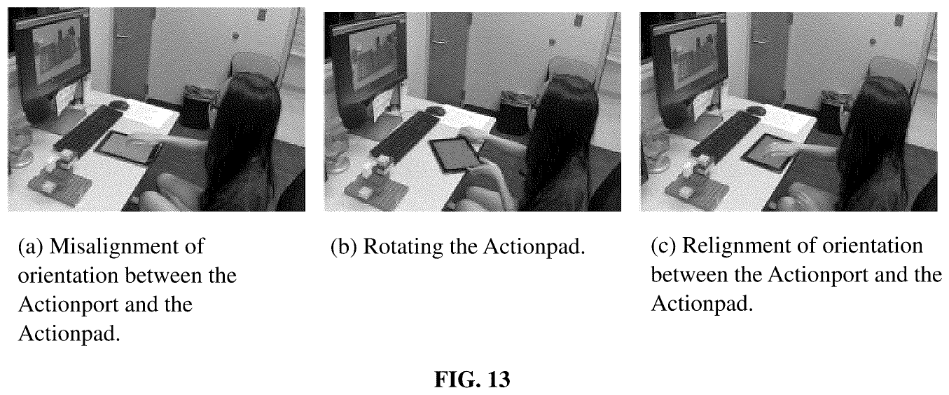

Vignette 9

| | |
|---|---|
| P7_{RH}: | [((Rotates her view on the desktop application's video display window clockwise))] |
| | [Actually, probably think this is better. ] (1.0) |
| | ((Looks at pre-built structure)) Yeah, Okay. (.) So, then you wanna take. (.) |
| | ((Touches tablet screen)) (2.0) |
| P7_{RH}: | [this. ] |
| | [((Moves her finger on the Actionpad screen to the left))] (.) (FIG. 13(a)) |
| P7_{RH}: | Where? Where is my pointer? (.) ((Sees the pointer is moving upwards as she is |
| | moving her finger left)) (2.0) hold on. (.) |
| | [((Turns the tablet clockwise)) ] (FIG. 13(b)) |
| | [Okay. There it is. That's fine. Makes sense.] (1.0) |
| P7_{RH}: | [((Moves the pointer to the red block on the left))] |
| | [So, this block right here. ] (FIG. 13(c)) |

This is the moment that the remote helper rotated back to the original view but she did not rotate her tablet at the same time. However, as soon as she moved the pointer and saw that the pointer moved in a different direction, she recognized she needed to also rotate the tablet and then checked again if the pointer in the Actionport moved in the direction she wanted. Vignette 9 shows the way the remote helper couples the direction of the Actionport with the Actionpad. All remote helpers who used the rotation function went through the same coupling process.

### 7. DISCUSSION

The disclosed system, consisting of an Actionport and an Actionpad, enables remote helpers to produce world-stabilized pointing and annotations without the need to “freeze” the remote view. The main takeaway is the demonstrated advantages over current approaches for producing world-stabilized annotations: in contrast to interfaces where remote helpers can only interact by taking a snapshot of the view first, the disclosed approach (1) supports pointing and thus deictic referencing in instruction, and, (2) supports live pointing and annotations while the view changes, and thus seamless communication without the need to disrupt the local work.

First, experimental results show the Actionport provided a suitable alignment of pointers and annotations to the intended target of the remote helper. In addition, none of the remote helpers indicated a loss of control of the pointer as the local workers moved their heads to explore the space. Because of this, the world-stabilized Actionport provided an embodiment for the remote helper to accurately provide deictic referencing and movement direction, without being affected by the local worker's head movement. Above all, pointing and annotating in the live mobile view had a positive effect on maintaining shared understanding between the remote helper and the local worker. For example, when the remote helper referred to a block and moved the pointer to a specific position, the local worker followed the pointer movement while holding the block almost simultaneously and then placing it in the intended position. However, the evidence shows that if given both the option of pointing or annotating, users will choose dynamic pointing for many references. More so, the Actionport provided a mechanism for achieving accurate deictic referencing. In essence, it would not be sufficient if only a pointer that participants did not feel to be accurate enough for effective use were provided.

Second, the Actionpad enabled remote helpers to continue manipulating the pointer regardless of changes in the live mobile view. Moreover, this was still true many times when the pointer was off-screen. Here, the remote helper asked the local worker to look back at the pointer in order to see its position, but in the meantime, they still continued interacting on the Actionpad. Interestingly, remote helpers quickly and intuitively understood the relation between their actions on the Actionpad and the result on the Actionport. For example, as there is a one-to-one correspondence between the XY coordinates on the Actionpad and Actionport, when the remote helper rotated the live mobile view, the Actionpad could also rotate in the same direction to case the mapping process. Even if the remote helper rotated the video view first and then forgot to rotate the Actionpad, they did so immediately when realizing that the movement (point or annotate) on the Actionpad did not match the expected outcome on the Actionport pointer.

a. Interaction for Creating World-Stabilized Annotations

Previous work proposed systems to support world-stabilized annotations by freezing the live view. However, the gap that occurs when the video stops and then restarts can cause disorientation and confusion for the remote helper. The disclosed interaction technique supports stabilized annotating on the live mobile view without freezing the view, which the study shows enabled smooth communication between collaborators and enabled the remote helper to immediately perceive their local worker's action. It's necessary to provide remote experts with mechanisms to navigate the local worker's space independently of the local worker's view—as when the local worker uses a HMD, they control the view. As beneficial this may be for visualizing the remote world, it may actually be disadvantageous when acting on the remote world, creating misalignment in communication and difficulty for providing immediate feedback.

Additional approaches and modifications to the disclosed system have been considered for example (1) feedforward mechanism: a hovering function where the remote helper first adjusts their pointer position in a personal view and when they are ready to communicate to the local worker, they press the screen (e.g. force touch) to perform the action; (2) show a 2D Reflection of the physical workspace on the Actionpad using 3D reconstruction: the image of the physical environment in which the Actionport is placed is reconstructed and it is reflected in Actionpad in real time. Lastly, formerly-placed annotations can be misinterpreted as the physical world changes beneath them. They may be mitigated by, for example, automatically removing the annotation when the real world is updated, or having mechanisms that create semantic links between annotations and objects (e.g. by drawing a line between them).

b. Dynamic Interaction for Remote Instruction in Live Mobile View

The Actionport provided a stable frame for the dynamic pointer to reference the live mobile view. Because of this, the remote helper frequently used the dynamic pointer to provide deictic referencing. If given the option of pointing or annotating, the remote helpers chose dynamic pointing for many references. The dynamic pointer is more beneficial than stabilized annotations on transient, short, procedural collaboration tasks. In addition, in situations where the live mobile view continues to change dynamically, immediate interaction is needed rather than stabilized annotation. An automatic erase function for remote instruction, in which annotations disappear after a few seconds, was more efficient than a manual erase function has been considered. The drawing annotations may need to be erased after completing each step of a task because the remaining annotations may cause confusion.

The disclosed system provided a manual erase function through the desktop application's toolbar, but some remote helpers did not use them, even though confusion could arise due to the remaining annotations. This may be because remote helpers interacted mainly through the Actionpad. Therefore, an automatic deletion function or the function of editing or erasing the previous annotations in the Actionpad directly has been considered. Finally, while disclosed system lets the remote helper reliably control the dynamic pointer in the live mobile view, the local worker does not have control over the pointer or annotations. The system may be modified to enable equal ability to interact on both sides.

c. Supporting Conversational Grounding and Situational Awareness

HoloMentor mainly supports maintaining conversational grounding and situational awareness by real-time pointing and annotating on the live mobile view. The use of the four types of gestures (deictic, iconic representations, spatial/distance, and kinetic/motion) facilitated the conversational grounding. HoloMentor provides deictic and kinetic/motion gestures through the dynamic pointer and spatial/distance and kinetic/motion gestures through annotations in the Actionport. Shared visual cues facilitated situational awareness so that the remote helpers provided better instruction. The experimental evaluation shows that the remote helper can perceive the local worker's action and change the pointing/annotating through the live mobile view, which supports the remote helper in maintaining situational awareness in a complex and dynamic environment.

Additionally, HoloMentor supports not only deictic instruction in the live mobile view but also it is compatible with setups commonly used in which a remote helper uses a desktop and a monitor. In remote instruction where the local worker is working with physical objects, AR could be more beneficial than VR because the local worker can see the objects directly. To see the physical objects through VR, not only would the system need to reconstruct the environment, but also the reconstructed environment in VR is not as accurate as of the real world.

### 8. CONCLUSION

The present disclosure provides an AR HMD-based collaborative system designed for remote instruction over live mobile views during local worker's completion of physical tasks—and empirical results of a laboratory study to evaluate its effectiveness and use. First, HoloMentor realizes pointing and annotating on a world-stabilized Actionport that lets the remote helper communicate with the local worker smoothly even though the view of the local worker's environment is not fixed. The Actionport is able to sufficiently align the remote helper's dynamic pointer and annotations and maintain that alignment with a mobile camera view. Second, the Actionpad entails a decoupling of interaction on a tablet (action) from its visualization in the live mobile view (perception). These two innovations tackle fundamental challenges that need addressing for collaborative systems based on AR through HMDs, where the view of the local worker's environment is mobile. The provided approach stands in contrast with prior work whose solution was to freeze the view and thus could not support deictic reference.

### REFERENCES

All publications, patent applications, patents, and other references identified herein are incorporated by reference in their entirety.
Steven Arild Wuyts Andersen, Peter Trier Mikkelsen, Lars Konge, Per Caye-Thomasen, and Mads Solvsten Sorensen. 2016. Cognitive load in distributed and massed practice in virtual reality mastoidectomy simulation. The Laryngoscope 126, 2 (2016), E74-E79.
David Anton, Gregorij Kurillo, and Ruzena Bajcsy. 2018. User experience and interaction performance in 2D/3D telecollaboration. Future Generation Computer Systems 82 (2018), 77-88.
Ignacio Avellino, Gilles Bailly, Mario Arico, Guillaume Morel, and Geoffroy Canlorbe. 2020. Multimodal and Mixed Control of Robotic Endoscopes. In Proceedings of the 2020 CHI Conference on Human Factors in Computing Systems (CHI '20). Association for Computing Machinery, Honolulu, HI, USA, 1-14. https://doi.org/10.1145/3313831.3376795
Ignacio Avellino, Gilles Bailly, Geoffroy Canlorbe, Jeremie Belgihti, Guillaume Morel, and Marie-Aude Vitrani. 2019. Impacts of Telemanipulation in Robotic Assisted Surgery. In Proceedings of the 2019 CHI Conference on Human Factors in Computing Systems (CHI '19). ACM, New York, NY, USA, 583:1-583:15. https://doi.org/10.1145/3290605.3300813 event-place: Glasgow, Scotland, UK.
Martin Bauer, Gerd Kortuem, and Zary Segall. 1999. “Where Are You Pointing At?” A Study of Remote Collaboration in a Wearable Videoconference System. In Proceedings of the 3rd IEEE International Symposium on Wearable Computers (ISWC '99). IEEE Computer Society, USA, 151. https://doi.org/10.1109/ISWC.1999.806696
Henry Chen, Austin S. Lec, Mark Swift, and John C. Tang. 2015. 3D Collaboration Method over HoloLensTM; and Skypem; End Points. In Proceedings of the 3rd International Workshop on Immersive Media Experiences (ImmersiveME '15). Association for Computing Machinery, New York, NY, USA, 27-30. https://doi.org/10.1145/2814347.2814350
Sicheng Chen, Miao Chen, Andreas Kunz, Asim Evren Yantac, Mathias Bergmark, Anders Sundin, and Morten Fjeld. 2013. SEMarbeta: mobile sketch-gesture-video remote support for car drivers. In Proceedings of the 4th Augmented Human International Conference (AH '13). Association for Computing Machinery, New York, NY, USA, 69-76. https://doi.org/10.1145/2459236.2459249
Barrett Ens, Joel Lanir, Anthony Tang, Scott Bateman, Gun Lec, Thammathip Piumsomboon, and Mark Billinghurst. 2019. Revisiting collaboration through mixed reality: The evolution of groupware. International Journal of Human-Computer Studies 131 (2019), 81-98.
Omid Fakourfar, Kevin Ta, Richard Tang, Scott Bateman, and Anthony Tang. 2016. Stabilized Annotations for Mobile Remote Assistance. In Proceedings of the 2016 CHI Conference on Human Factors in Computing Systems (CHI '16). Association for Computing Machinery, New York, NY, USA, 1548-1560. https://doi.org/10.1145/2858036.2858171
Yuanyuan Feng, Hannah McGowan, Azin Semsar, Hamid R. Zahiri, Ivan M. George, Adrian Park, Andrea Kleinsmith, and Helena Mentis. 2019. Virtual pointer for gaze guidance in laparoscopic surgery. Surgical Endoscopy 34 (Oct. 2019), 3533-3539. https://doi.org/10.1007/s00464-019-07141-x
Yuanyuan Feng, Hannah McGowan, Azin Semsar, Hamid R Zahiri, Ivan M George, Adrian Park, Andrea Kleinsmith, and Helena Mentis. 2020. Virtual pointer for gaze guidance in laparoscopic surgery. Surgical endoscopy 34, 8 (2020), 3533-3539.
Yuanyuan Feng, Hannah McGowan, Azin Semsar, Hamid R Zahiri, Ivan M George, Timothy Turner, Adrian Park, Andrea Kleinsmith, and Helena M Mentis. 2018. A virtual pointer to support the adoption of professional vision in laparoscopic training. International journal of computer assisted radiology and surgery 13, 9 (2018), 1463-1472.
Yuanyuan Feng, Hannah McGowan, Azin Semsar, Hamid R. Zahiri, Ivan M. George, Timothy Turner, Adrian Park, Andrea Kleinsmith, and Helena M. Mentis. 2018. A virtual pointer to support the adoption of professional vision in laparoscopic training. International Journal of Computer Assisted Radiology and Surgery 13, 9 (Sept. 2018), 1463-1472. https://doi.org/10.1007/s11548-018-1792-9
Susan R Fussell, Leslie D Setlock, Jie Yang, Jiazhi Ou, Elizabeth Mauer, and Adam DI Kramer. 2004. Gestures over video streams to support remote collaboration on physical tasks. Human-Computer Interaction 19, 3 (2004), 273-309.
Steffen Gauglitz, Cha Lec, Matthew Turk, and Tobias Höllerer. 2012. Integrating the physical environment into mobile remote collaboration. In Proceedings of the 14th international conference on Human-computer interaction with mobile devices and services (MobileHCI '12). Association for Computing Machinery, New York, NY, USA, 241-250. https://doi.org/10.1145/2371574.2371610
Steffen Gauglitz, Benjamin Nuernberger, Matthew Turk, and Tobias Höllerer. 2014. In touch with the remote world: remote collaboration with augmented reality drawings and virtual navigation. In Proceedings of the 20th ACM Symposium on Virtual Reality Software and Technology (VRST '14). Association for Computing Machinery, New York, NY, USA, 197-205. https://doi.org/10.1145/2671015.2671016
Steffen Gauglitz, Benjamin Nuernberger, Matthew Turk, and Tobias Höllerer. 2014. World-stabilized annotations and virtual scene navigation for remote collaboration. In Proceedings of the 27th annual ACM symposium on User interface software and technology-UIST '14. ACM Press, Honolulu, Hawaii, USA, 449-459. https://doi.org/10.1145/2642918.2647372
Darren Gergle, Robert E Kraut, and Susan R Fussell. 2013. Using visual information for grounding and awareness in collaborative tasks. Human-Computer Interaction 28, 1 (2013), 1-39.
Carl Gutwin and Saul Greenberg. 2002. A descriptive framework of workspace awareness for real-time groupware. Computer Supported Cooperative Work (CSCW) 11, 3 (2002), 411-446.
Christian Heath, Paul Luff, Hideaki Kuzuoka, Keiichi Yamazaki, and Shinya Oyama. 2001. Creating Coherent Environments for Collaboration. In ECSCW 2001: Proceedings of the Seventh European Conference on Computer Supported Cooperative Work 16-20 Sep. 2001, Bonn, Germany, Wolfgang Prinz, Matthias Jarke, Yvonne Rogers, Kjeld Schmidt, and Volker Wulf (Eds.). Springer Netherlands, Dordrecht, 119-138. https://doi.org/10.1007/0-306-48019-0_7
Richard Heiberger and Naomi Robbins. 2014. Design of diverging stacked bar charts for Likert scales and other applications. Journal of Statistical Software 57 (2014), 1-32.
Alexa Hepburn and Galina B Bolden. 2013. The conversation analytic approach to transcription. The handbook of conversation analysis 1 (2013), 57-76.
Wcidong Huang, Leila Alem, Franco Tecchia, and Henry Been-Lirn Duh. 2018. Augmented 3D hands: a gesture-based mixed reality system for distributed collaboration. Journal on Multimodal User Interfaces 12, 2 (2018), 77-89.
Weidong Huang, Seungwon Kim, Mark Billinghurst, and Leila Alem. 2019. Sharing hand gesture and sketch cues in remote collaboration. Journal of Visual Communication and Image Representation 58 (2019), 428-438.
Brennan Jones, Anna Witcraft, Scott Bateman, Carman Neustaedter, and Anthony Tang. 2015. Mechanics of Camera Work in Mobile Video Collaboration. In Proceedings of the 33rd Annual ACM Conference on Human Factors in Computing Systems (CHI '15). Association for Computing Machinery, New York, NY, USA, 957-966. https://doi.org/10.1145/2702123.2702345
Seungwon Kim, Gun Lec, Mark Billinghurst, and Weidong Huang. 2020. The combination of visual communication cues in mixed reality remote collaboration. Journal on Multimodal User Interfaces 14, 4 (2020), 321-335.
Scungwon Kim, Gun Lec, Nobuchika Sakata, and Mark Billinghurst. 2014. Improving co-presence with augmented visual communication cues for sharing experience through video conference. In 2014 IEEE International Symposium on Mixed and Augmented Reality (ISMAR). IEEE Computer Society, USA, 83-92. https://doi.org/10.1109/ISMAR.2014.6948412
Seungwon Kim, Gun A. Lee, Sangtac Ha, Nobuchika Sakata, and Mark Billinghurst. 2015. Automatically Freezing Live Video for Annotation during Remote Collaboration. In Proceedings of the 33rd Annual ACM Conference Extended Abstracts on Human Factors in Computing Systems (CHI EA '15). Association for Computing Machinery, New York, NY, USA, 1669-1674. https://doi.org/10.1145/2702613.2732838.
Seungwon Kim, Gun A. Lee, and Nobuchika Sakata. 2013. Comparing pointing and drawing for remote collaboration. In 2013 IEEE International Symosium on Mixed and Augmented Reality (ISMAR). IEEE Computer Society, USA, 1-6. https://doi.org/10.1109/ISMAR.2013.6671833
David Kirk, Andy Crabtree, and Tom Rodden. 2005. Ways of the Hands. In ECSCW 2005, Hans Gellersen, Kjeld Schmidt, Michel Beaudouin-Lafon, and Wendy Mackay (Eds.). Springer Netherlands, Dordrecht, 1-21. https://doi.org/10.1007/1-4020-4023-7_1
Robert E. Kraut, Susan R. Fussell, and Jane Siegel. 2003. Visual Information As a Conversational Resource in Collaborative Physical Tasks. Hum.-Comut. Interact. 18, 1 (June 2003), 13-49. https://doi.org/10.1207/S15327051HCI1812_2
Morgan Le Chenechal, Thierry Duval, Valerie Gouranton, Jerome Royan, and Bruno Arnaldi. 2019. Help! I Need a Remote Guide in my Mixed Reality Collaborative Environment. Frontiers in Robotics and AI 6 (2019), 106.
L. Lingard, S. Espin, S. Whyte, G. Regehr, G. R. Baker, R. Reznick, J. Bohnen, B. Orser, D. Doran, and E. Grober. 2004. Communication failures in the operating room: an observational classification of recurrent types and effects. BMJ Quality & Safety 13, 5 (Oct. 2004), 330-334. https://doi.org/10.1136/qshc.2003.008425
Stephan Lukosch, Heide Lukosch, Dragog Datcu, and Marina Cidota. 2015. Providing information on the spot: Using augmented reality for situational awareness in the security domain. Computer Supported Cooperative Work (CSCW) 24, 6 (2015), 613-664.
Sophie Maria, Solene Lambert, and Ignacio Avellino. 2022. From Deja vu to Dejà vecu: Reliving Surgery in Post-Operative Debriefing. In 2022 IEEE Conference on Virtual Reality and 3D User Interfaces Abstracts and Workshops (VRW). IEEE Computer Society, Los Alamitos, CA, USA, 462-465. https://doi.org/10.1109/VRW55335.2022.00102
Helena M. Mentis, Ignacio Avellino, and Jwawon Seo. 2022. AR HMD for Remote Instruction in Healthcare. In 2022 IEEE Conference on Virtual Reality and 3D User Interfaces Abstracts and Workshops (VRW). IEEE Computer Society, Los Alamitos, CA, USA, 437-440. https://doi.org/10.1109/VRW55335.2022.00096
Helena M. Mentis, Yuanyuan Feng, Azin Sem sar, and Todd A. Ponsky. 2020. Remotely Shaping the View in Surgical Telementoring. In Proceedings of the 2020 CHI Conference on Human Factors in Computing Systems (CHI '20). Association for Computing Machinery, Honolulu, HI, USA, 1-14. https://doi.org/10.1145/3313831.3376622
Thammathip Piumsomboon, Arindam Dey, Barrett Ens, Gun Lec, and Mark Billinghurst. 2019. The effects of sharing awareness cues in collaborative mixed reality. Frontiers in Robotics and AI 6 (2019), 5.
Aaron Stafford, Wayne Piekarski, and Bruce Thomas. 2006. Implementation of god-like interaction techniques for supporting collaboration between outdoor AR and indoor tabletop users. In Proceedings of the 5th IEEE and ACM International Symposium on Mixed and Augmented Reality (ISMAR '06). IEEE Computer Society, USA, 165-172. https://doi.org/10.1109/ISMAR.2006.297809
Peng Wang, Shusheng Zhang, Xiaoliang Bai, Mark Billinghurst, Weiping He, Mengmeng Sun, Yongxing Chen, Hao Lv, and Hongyu Ji. 2019. 2.5 DHANDS: a gesture-based MR remote collaborative platform. The International Journal of Advanced Manufacturing Technology 102, 5 (2019), 1339-1353.
Douglas A. Wiegmann, Andrew W. ElBardissi, Joseph A. Dearani, Richard C. Daly, and Thoralf M. Sundt. 2007. Disruptions in surgical flow and their relationship to surgical errors: An exploratory investigation. Surgery 142, 5 (Nov. 2007), 658-665. https://doi.org/10.1016/j.surg.2007.07.034

What is claimed is:

1. A collaborative work system comprising:
a head mounted device, sized and configured to be worn by a local worker, including,
a worker display and
a camera configured to capture a video feed from the perspective of the local worker;
an input device configured to accept inputs from a remote helper, including, a helper display; and
a shared virtual workspace displayed on the worker display and the helper display, comprising the video feed and annotations corresponding to the received inputs.

2. The system of claim 1, wherein the virtual workspace further comprises a fixed coordinate space within a world-stabilized two-dimensional plane.

3. The system of claim 1, wherein the virtual workspace includes a cursor configured to move according to the inputs from the remote helper.

4. The system of claim 1, wherein the input device includes a touchpad configured to accept touch inputs from the remote helper.

5. The system of claim 1, wherein the input device includes an erase function configured to erase select annotations.

6. The system of claim 1, further comprising a communication device configured to send and receive instructions between the local worker and the remote helper.

7. The system of claim 6, wherein the communication device is a two-way audio-based communication device.

8. A method for collaborative work, the method comprising:
capturing a video feed from the perspective of a local worker;
projecting a virtual workspace over the video feed;
displaying said video feed to a remote helper;
recording inputs from the remote helper in the form of annotations;
combining video feed and annotations to create an annotated video; and
displaying annotated video feed to local worker.

9. The method of claim 8, wherein the method further comprises projecting a fixed coordinate space within a world-stabilized two-dimensional plane within the workspace.

10. The method of claim 8, wherein the method further comprises erasing annotations after annotated video is displayed to local worker.

11. The method of claim 8, wherein the method further comprises manipulating a cursor within the workspace.

12. The method of claim 8, wherein the method further comprises sending audio instructions between the local worker and the remote helper.

13. The method of claim 8, wherein the annotated video is displayed to the local worker using an augmented reality headset.

14. The method of claim 8, wherein the inputs are recorded using a touchpad.
